(19) United States
(12) Patent Application Publication
(10) Pub. No.: US 2023/0053538 A1
(43) Pub. Date: Feb. 23, 2023

(54) UNMANNED AERIAL DEVICE WITH CLEANING FUNCTION

(71) Applicant: Yao-Chang Lin, Hsinchu City (TW)

(72) Inventor: Yao-Chang Lin, Hsinchu City (TW)

(21) Appl. No.: 17/855,822

(22) Filed: Jul. 1, 2022

(30) Foreign Application Priority Data
Aug. 19, 2021 (TW) 110209817

(51) Int. Cl. B64D 1/18; B64D 47/08; B64C 39/02

(52) U.S. Cl. CPC B64D 1/18; B64D 47/08; B64C 39/024; B64C 2201/027; B64C 2201/123

(57) ABSTRACT

An unmanned aerial device having cleaning function includes a fuselage, a washing assembly and two propulsion assemblies. The washing assembly is disposed at a head of the fuselage. The propulsion assemblies are connected to two opposite sides of the fuselage. The two opposite sides are connected to the head. The propulsion assemblies each have an axial direction, and the axial direction is parallel to a direction from a bottom of the fuselage to a top of the fuselage.

### FIELD OF THE INVENTION

The present invention relates to an aerial device, and more particularly to an unmanned aerial device with cleaning function.

### BACKGROUND OF THE INVENTION

The insulator of a high-voltage electrical transmission tower has the function of supporting the transmission line and insulation, and its appearance is usually like a white disc. However, because high-voltage electrical transmission tower is exposed to outdoor environment for a long time, salt, dust and other contaminants in the air tend to accumulate on the insulator. If the contaminated insulator is not cleaned timely, it is prone to cause current leakage, which may cause sparks, and may even cause a power outage accident.

In the prior art, cleaning the insulators on a high-voltage electrical transmission tower usually requires a man to climb the tower. However, the height of a high-voltage electrical transmission tower is usually between 60 to 100 meters, and therefore a serious accident may happen when a man falls from the tower.

### SUMMARY OF THE INVENTION

The present invention provides an unmanned aerial device with cleaning function to clean objects that are higher from the ground.

The unmanned aerial device with cleaning function disclosed in present invention includes a fuselage, a washing assembly and two propulsion assemblies. The washing assembly is disposed on a head of the fuselage. The two propulsion assemblies are connected to two opposite sides of the fuselage connected to the head. The two propulsion assemblies each have an axial direction, and the axial direction is parallel to a direction from a bottom of the fuselage to a top of the fuselage.

In an embodiment of the present invention, the aforementioned unmanned aerial device with cleaning function further includes a photographing element disposed on the head.

In an embodiment of the present invention, the aforementioned unmanned aerial device with cleaning function further includes a transparent cover connected to the head and covering the photographing element.

In an embodiment of the present invention, the washing assembly includes a spraying pipe and a steering element. The steering element is disposed on the head, and the spraying pipe is connected to the steering element.

In an embodiment of the present invention, the head of the fuselage has a concave portion. The steering element is disposed in the concave portion.

In an embodiment of the present invention, the aforementioned unmanned aerial device with cleaning function further includes a liquid storage container and a booster pump disposed in the fuselage. The booster pump is connected between the liquid storage container and the spraying pipe.

In an embodiment of the present invention, a distance between the two opposite sides of the fuselage is smaller than a distance between the head and a tail of the fuselage.

In an embodiment of the present invention, the two propulsion assemblies are close to the top of the fuselage.

In an embodiment of the present invention, the aforementioned unmanned aerial device with cleaning function further includes a landing frame disposed on the bottom of the fuselage.

In an embodiment of the present invention, the two propulsion assemblies each include a fan propeller.

In an embodiment of the present invention, the two propulsion assemblies each further include a direction control panel disposed at an air outlet of the fan propeller.

In an embodiment of the present invention, the aforementioned unmanned aerial device with cleaning function also includes a power unit and a power transmission component disposed in the fuselage, wherein the power transmission component is connected between the power unit and the two fan propellers.

In an embodiment of the present invention, the aforementioned unmanned aerial device with cleaning function further includes a circuit assembly. The circuit assembly includes a control module and a wireless transceiver module that are electrically connected to each other. The wireless transceiver module is configured to receive wireless control signals, and the control module is configured to control the two propulsion assemblies and the washing assembly according to wireless control signals.

In an embodiment of the present invention, the circuit assembly further includes a sensing module electrically connected to the control module. The sensing module is configured to collect flight data, and the control module is configured to transmit the flight data to the wireless transceiver module.

In an embodiment of the present invention, the aforementioned unmanned aerial device with cleaning function further includes a battery electrically connected to the circuit assembly.

In an embodiment of the present invention, the aforementioned unmanned aerial device with cleaning function further includes a photographing element disposed on the head. The control module is also electrically connected to the photographing element, and the control module is configured to drive the photographing element and the washing assembly to steer synchronously.

The present invention adopts an unmanned aerial device with cleaning function, wherein the washing assembly is disposed on the head of the fuselage of the unmanned aerial device, and the two propulsion assemblies are connected to two opposite sides of the fuselage connected to the head. Specifically, since the axial direction of the two propulsion assemblies is parallel to a direction from a bottom of the fuselage to a top of the fuselage, the unmanned aerial device may take off and land in an attitude substantially perpendicular to the ground, and may also hover at a certain height after takeoff. Therefore, the unmanned aerial device with cleaning function of the present invention may clean an object with great height above ground.

### BRIEF DESCRIPTION OF THE DRAWINGS

The present invention will become more readily apparent to those ordinarily skilled in the art after reviewing the following detailed description and accompanying drawings, in which:

FIG. 1 is a three-dimensional schematic diagram of an unmanned aerial device with cleaning function according to an embodiment of the present invention;

FIG. 2 is a schematic top diagram of the unmanned aerial device with cleaning function of FIG. 1;

FIG. 3 is an internal schematic diagram of the unmanned aerial device with cleaning function of FIG. 1;

FIG. 4 is an internal schematic diagram of the unmanned aerial device with cleaning function of FIG. 1 viewing from another angle;

FIG. 5 is a three-dimensional schematic diagram of a power unit and a power transmission component of the unmanned aerial device with cleaning function of FIG. 4;

FIG. 6 is a three-dimensional schematic diagram of a direction control panel of the propulsion assembly of the unmanned aerial device with cleaning function of FIG. 1; and

FIG. 7 is a block diagram of the unmanned aerial device with cleaning function of FIG. 1.

### DETAILED DESCRIPTION OF PREFERRED EMBODIMENTS

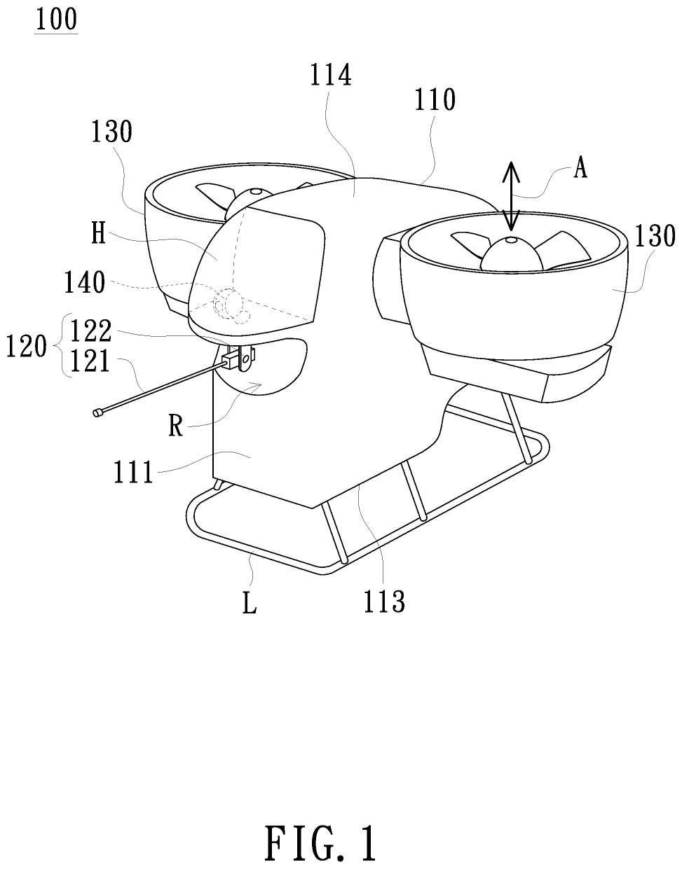

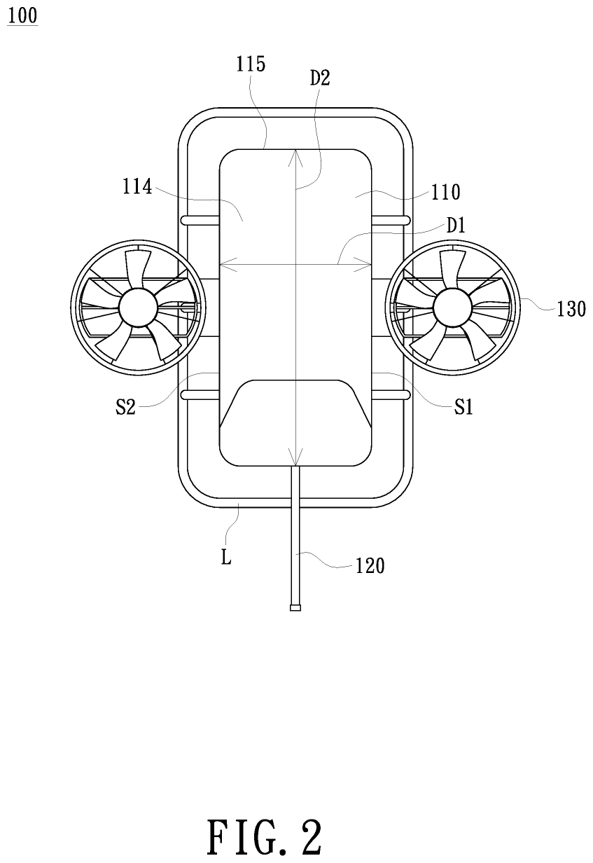

FIG. 1 is a three-dimensional schematic diagram of an unmanned aerial device with cleaning function according to an embodiment of the present invention. FIG. 2 is a schematic top diagram of the unmanned aerial device with cleaning function of FIG. 1. Referring to FIGS. 1 and 2, the unmanned aerial device 100 with cleaning function includes a fuselage 110, a washing assembly 120 and two propulsion assemblies 130. The washing assembly 120 is disposed on a head 111 of the fuselage 110. The propulsion assemblies 130 are connected to the two opposite sides S1 and S2 (labeled in FIG. 2) of the fuselage 110 connected to the head 111. The propulsion assemblies 130 each have an axial direction A (labeled in FIG. 1), and the axial direction A is parallel to a direction from a bottom 113 of the fuselage 110 to a top 114 of the fuselage 110. In this embodiment, the unmanned aerial device 100 with cleaning function may be used for cleaning electric transmission towers, building exterior, etc., but the present invention is not limited thereto. In addition, the unmanned aerial device with cleaning function 100 may be manipulated by means of wireless remote control. The specific structure of the unmanned aerial device 100 with cleaning function will be introduced first, and the relevant features of the wireless remote control will be described in the following paragraphs.

The shape of the fuselage 110 may be designed according to different actual needs. For example, in this embodiment, the distance D1 (labeled in FIG. 2) between the two opposite sides S1 and S2 of the fuselage 110 may be smaller than the distance D2 (labeled in FIG. 2) between the head 111 and the tail 115 of the fuselage 110, so that the fuselage 110 has a shape suitable for vertical take-off and landing. It may be understood that the shape of the fuselage 110 in other embodiments may be different to that in this embodiment. In addition, the bottom 113 of the fuselage 110 faces the ground when the unmanned aerial device 100 with cleaning function lands, so the unmanned aerial device 100 with cleaning function of this embodiment may further include a landing frame L. The landing frame L is disposed on the bottom 113 of the fuselage 110 to prevent the bottom 113 of the fuselage 110 from directly touching the ground when landing. Incidentally, the propulsion assemblies 130 of this embodiment are, for example, close to the top 114 of the fuselage 110, but the present invention is not limited thereto.

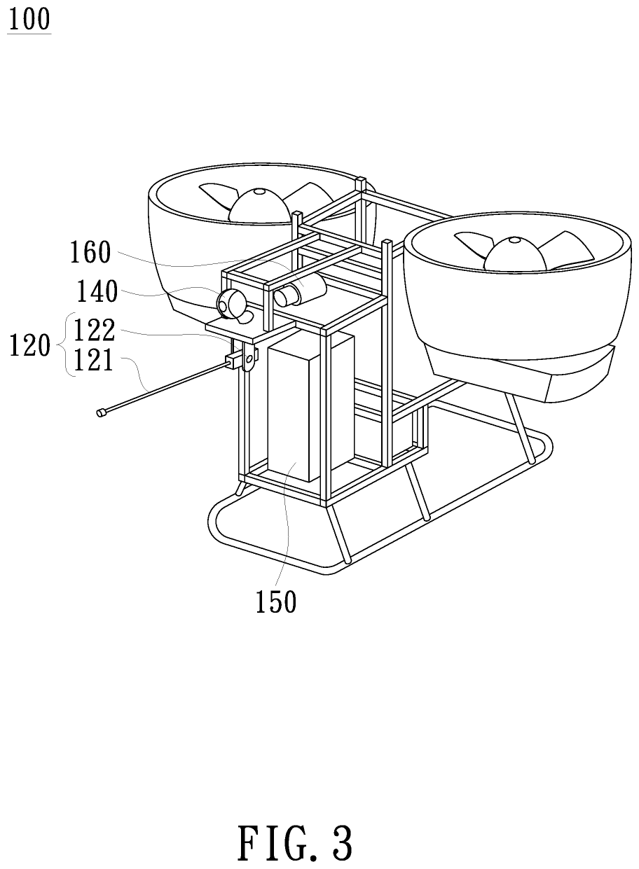

The washing assembly 120 of this embodiment may include a spraying pipe 121 and a steering element 122. The steering element 122 is disposed on the head 111 of the fuselage 110, and the spraying pipe 121 is connected to the steering element 122. Specifically, the steering element 122 may rotate within a specific angle range, so that the spraying pipe 121 may spray the liquid at different angles. In addition, the head 111 of the fuselage 110 of this embodiment may have a concave portion R, and the steering element 122 is disposed in the concave portion R, so that the spraying pipe 121 connected to the steering element 122 may steer in a larger angle range. The aforementioned angle range may be changed according to actual needs, and the present invention does not limit the specific features of the steering element 122 such as the specific steering angle range and steering direction. In addition, referring to FIGS. 1 and 3 together, the unmanned aerial device 100 with cleaning function may further include a liquid storage container 150 and a booster pump 160. The liquid storage container 150 and the booster pump 160 are disposed in the fuselage 110, and the booster pump 160 is connected between the liquid storage container 150 and the spraying pipe 121. Specifically, the liquid storage container 150 may store cleaning liquid, and the liquid storage container 150 is communicated with the booster pump 160 and the spraying pipe 121 through, for example, a plurality of connecting pipes (not shown), so that the booster pump 160 may withdraw the cleaning liquid from the liquid storage container 150 and pump the cleaning liquid to the spraying pipe 121.

In order to facilitate the observation of the operation of the washing assembly 120, the unmanned aerial device 100 with cleaning function may further include a photographing element 140. The photographing element 140 is disposed on the head 111 of the fuselage 110 to provide an image of the washing assembly 120 spraying an object viewing from the head 111. Furthermore, the photographing element 140 of this embodiment may also steer synchronously with the steering element 122 of the washing assembly 120, so as to more accurately capture images of the washing assembly 120 spraying an object. The detailed structure allowing the photographing element 140 and the steering element 122 to steer synchronously will be described in the following paragraphs. In addition, the unmanned aerial device 100 with cleaning function may further include a transparent cover H (shown in FIG. 1). The transparent cover H is connected to the head 111 and covers the photographing element 140 to protect the photographing element 140. Incidentally, the washing assembly 120 of this embodiment may be disposed between the photographing element 140 and the bottom 113 of the fuselage 110, but the present invention is not limited thereto.

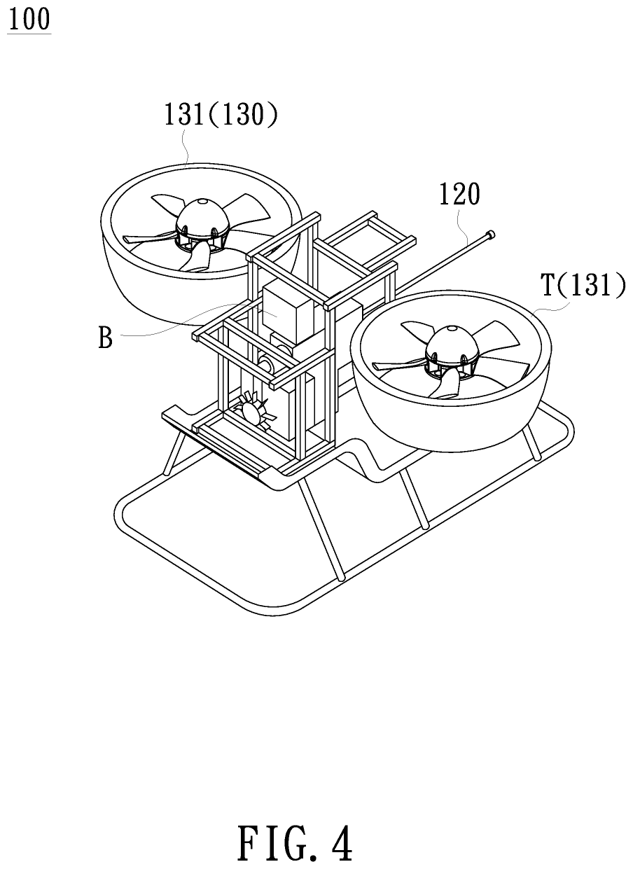

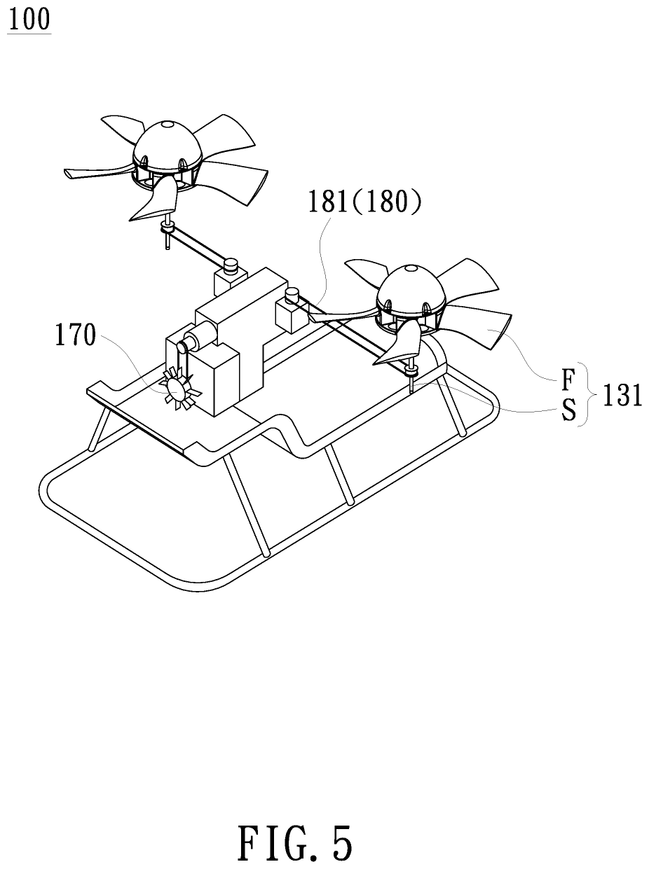

FIG. 4 is an internal schematic diagram of the unmanned aerial device with cleaning function of FIG. 1 viewing from another angle. FIG. 5 is a three-dimensional schematic diagram of a power unit and a power transmission component of the unmanned aerial device with cleaning function of FIG. 4. Referring to FIGS. 4 and 5, each of the two propulsion assemblies 130 may include a fan propeller 131. Specifically, the fan propeller 131 may include a rotating shaft S, a fan blade set F and a tubular casing T. The rotating shaft S is connected to the center of the fan blade set F, and both the rotating shaft S and the fan blade set F are disposed in the tubular casing T. In addition, the unmanned aerial device 100 with cleaning function may further include a power unit 170 and a power transmission component 180. The power unit 170 and the power transmission component 180 are both disposed in the fuselage 110, and the power transmission component 180 is connected between the power unit 170 and the fan propeller 131. The power unit 170 may provide power to the fan propeller 131 via the power transmission component 180 to drive the fan blade set F to rotate to generate propulsion power. Furthermore, the power transmission component 180 may include a plurality of transmission belts 181 connected to the power unit 170 and the rotating shaft S of the fan propeller 131. The transmission belts 181 transmit the power generated by the power unit 170 to the fan propeller 131. Incidentally, the power unit 170 of this embodiment includes, for example, a gasoline engine, but the power unit 170 in other embodiments may include an electric engine or a hybrid electric engine. In addition, the specific structure of the power transmission component 180 in other embodiments may be different to that in this embodiment. The present invention does not limit these detailed features.

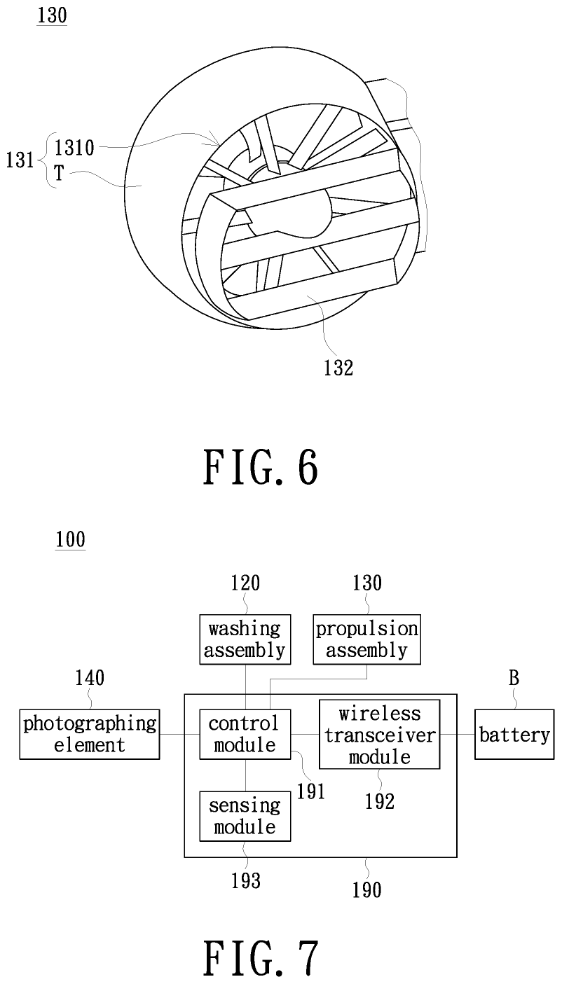

Please refer to FIG. 6. In order to adjust the exhaust direction of the fan propeller 131, each of the two propulsion assemblies 130 of this embodiment may further include a direction control panel 132. The fan propeller 131 may have an air outlet 1310, and the air outlet 1310 is formed, for example, at one end of the tubular casing T. The airflow generated by the rotation of the fan blade set F (labeled in FIG. 5) discharges from the air outlet 1310. The direction control panel 132 is disposed at the air outlet 1310 to adjust the exhaust direction of the fan propeller 131, thereby changing the flight direction of the unmanned aerial device 100 with cleaning function. It may be understood that the direction control panel 132 shown in FIG. 6 is only an example, and the specific structure of the direction control panel 132 in other embodiments may be changed according to actual needs.

In this embodiment, the unmanned aerial device 100 with cleaning function may be manipulated by means of wireless remote control. Referring to FIGS. 1 and 7 together, the unmanned aerial device 100 with cleaning function may further include a circuit assembly 190. The circuit assembly 190 includes a control module 191 and a wireless transceiver module 192 that are electrically connected to each other. The wireless transceiver module 192 may receive a wireless control signal, and the control module 191 may control the two propulsion assemblies 130 and the washing assembly 120 according to the wireless control signal. Specifically, the aforementioned wireless control signal may be sent by a remote controller (not shown), and the control module 191 may manipulate the unmanned aerial device 100 with cleaning function accordingly. For example, the control module 191 may control the direction control panel 132 (shown in FIG. 6) of the propulsion assemblies 130 to change the flight direction of the unmanned aerial device 100 with cleaning function. In addition, the control module 191 of this embodiment may also be electrically connected to the photographing element 140, so that the control module 191 may also control the photographing element 140 to shoot or steer according to the aforementioned wireless control signal. Furthermore, the control module 191 may drive the photographing element 140 and the washing assembly 120 to steer synchronously, so that the photographing element 140 may more accurately capture the image of the washing assembly 120 spraying an object. In other embodiments, the control module 191 may also control the booster pump 160, the steering element 122 of the washing assembly 120 (all shown in FIG. 3) and the power unit 170 (shown in FIG. 5), etc., while the aforementioned detailed features are not limited in the present invention. The control module 191 of this embodiment may include, for example, a microcontroller unit (MCU) and a graphics processing unit (GPU), and the wireless transceiver module 192 may include Bluetooth, radio frequency (RF) or mobile networks, but the present invention is not limited thereto.

Please continue to refer to FIG. 7. The circuit assembly 190 may further include a sensing module 193, and the sensing module 193 is electrically connected to the control module 191. The sensing module 193 may collect flight data, and the control module 191 may transmit the flight data to the wireless transceiver module 192. For example, the aforementioned flight data may include elevation angle, depression angle, temperature, wind speed, and coordinates, etc., but the present invention does not limit the specific content of the flight data. In addition, the control module 191 may gain information such as flight attitude, flight altitude, flight speed and position by calculating the aforementioned flight data.

Please refer to FIGS. 4 and 7 together. The unmanned aerial device 100 with cleaning function may further include a battery B. The battery B is electrically connected to the circuit assembly 190 to supply power to the circuit assembly 190. In addition, the battery B may also supply power to the power unit 170 in the embodiment in which the power unit 170 is configured as an electric engine. The battery B in this embodiment may include a lithium iron phosphate battery, a lithium iron titanate battery, a ternary lithium battery, or a solid state battery, etc., but is not limited thereto.

To sum up, the present invention provides an unmanned aerial device with cleaning function. In this unmanned aerial device with cleaning function, the washing assembly is disposed on the head of the fuselage of the unmanned aerial device, and the two propulsion assemblies are connected to two opposite sides of the fuselage connected to the head. Specifically, because the axial direction of the two propulsion assemblies is parallel to a direction from the bottom of the fuselage to the top of the fuselage, the unmanned aerial device may take off and land in an attitude substantially perpendicular to the ground, and may also hover at a certain height after takeoff. Therefore, the unmanned aerial device with cleaning function of the present invention may clean an object that is higher from the ground.

While the invention has been described in terms of what is presently considered to be the most practical and preferred embodiments, it is to be understood that the invention needs not be limited to the disclosed embodiment. On the contrary, it is intended to cover various modifications and similar arrangements comprised within the spirit and scope of the appended claims which are to be accorded with the broadest interpretation so as to encompass all such modifications and similar structures.

What is claimed is:

1. An unmanned aerial device with cleaning function, comprising:
a fuselage;
a washing assembly, disposed on a head of the fuselage; and
two propulsion assemblies, connected to opposite sides of the fuselage connected to the head, wherein the two propulsion assemblies each have an axial direction parallel to a direction from a bottom of the fuselage to a top of the fuselage.

2. The unmanned aerial device with cleaning function according to claim 1, further comprising a photographing element disposed on the head.

3. The unmanned aerial device with cleaning function according to claim 2, further comprising a transparent cover connected to the head and covering the photographing element.

4. The unmanned aerial device with cleaning function according to claim 1, wherein the washing assembly comprises a spraying pipe and a steering element, the steering element is disposed on the head, and the spraying pipe is connected to the steering element.

5. The unmanned aerial device with cleaning function according to claim 4, wherein the head of the fuselage has a concave portion, and the steering element is disposed in the concave portion.

6. The unmanned aerial device with cleaning function according to claim 4, further comprising a liquid storage container and a booster pump disposed in the fuselage, wherein the booster pump is connected between the liquid storage container and the spraying pipe.

7. The unmanned aerial device with cleaning function according to claim 1, wherein a distance between the two opposite sides of the fuselage is smaller than a distance between the head and a tail portion of the fuselage.

8. The unmanned aerial device with cleaning function according to claim 1, wherein the two propulsion assemblies are close to the top of the fuselage.

9. The unmanned aerial device with cleaning function according to claim 1, further comprising a landing frame disposed on the bottom of the fuselage.

10. The unmanned aerial device with cleaning function according to claim 1, wherein the two propulsion assemblies each further comprise a fan propeller.

11. The unmanned aerial device with cleaning function according to claim 10, wherein the two propulsion assemblies each further comprise a direction control panel disposed at an air outlet of the respective fan propeller.

12. The unmanned aerial device with cleaning function according to claim 10, further comprising a power unit and a power transmission component disposed in the fuselage, wherein the power transmission component is connected between the power unit and the two fan propellers.

13. The unmanned aerial device with cleaning function according to claim 1, further comprising a circuit assembly, wherein the circuit assembly comprises a control module and a wireless transceiver module electrically connected to each other, the wireless transceiver module is configured to receive a wireless control signal, and the control module is configured to control the two propulsion assemblies and the washing assembly according to the wireless control signal.

14. The unmanned aerial device with cleaning function according to claim 13, wherein the circuit assembly further comprises a sensing module electrically connected to the control module, the sensing module is configured to collect flight data, and the control module is configured to transmit the flight data to the wireless transceiver module.

15. The unmanned aerial device with cleaning function according to claim 13, further comprising a battery electrically connected to the circuit assembly.

16. The unmanned aerial device with cleaning function according to claim 13, further comprising a photographing element disposed on the head, wherein the control module is also electrically connected to the photographing element, and the control module is configured to synchronously steer the photographing element and the washing assembly.
